(19) United States
(12) Patent Application Publication
(10) Pub. No.: US 2014/0274081 A1
(43) Pub. Date: Sep. 18, 2014

(54) COORDINATED VIRTUAL DEVICES USING DISPARATE WIRELESS COMMUNICATION TECHNOLOGIES

(71) Applicant: TELEFONAKTIEBOLAGET L M ERICSSON (PUBL), Stockholm (SE)

(72) Inventors: Adrien Joseph COMEAU, Ottawa (CA); Seyed Hossein SEYEDMEHDI, Toronto (CA)

(73) Assignee: Telefonaktiebolaget L M Ericsson (publ), Stockholm (SE)

(21) Appl. No.: 13/846,150

(22) Filed: Mar. 18, 2013

(51) Int. Cl. H04W 72/12; H04W 88/06

(52) U.S. Cl. CPC H04W 72/1215; H04W 88/06
USPC 455/450; 455/553.1

(57) ABSTRACT

Methods and systems for coordinated operation of a plurality of user equipments are disclosed. In one embodiment, a method is provided that includes receiving at a first user equipment via a first radio access technology, first data from a base station. The method also includes transmitting, by the first user equipment to a second user equipment station via a second radio access technology, the first data received from the base station.

### TECHNICAL FIELD

The present invention relates to interoperation of wireless communication networks, and more particularly to coordination of transmissions of a plurality of user equipments using two different wireless access technologies.

### BACKGROUND

WiFi, also termed WLAN, has become a ubiquitous wireless technology for data communication in the unlicensed radio spectrum. The Institute of Electrical and Electronic Engineers, IEEE, standard IEEE 802.11 defines the protocol stack and functions used by WiFi access points, APs. IEEE 802.15.3c specifies another higher frequency protocol referred to as WiGig. In contrast to these unlicensed spectrums, to the licensed radio spectrum, 3^{rd} generation partnership project, long term evolution, 3GPP LTE, wireless communication technology is rapidly being deployed. LTE is the 4^{th} generation of wireless cellular communications. The protocol stack of LTE is currently defined by the 3GPP. The vast majority of smartphone devices now manufactured include both 3GPP cellular (3G and 4G) and WiFi capabilities. These user devices have separate radio and protocol stacks for each technology (termed dual stack or dual radio). Both wireless technologies operate simultaneously and independently.

For example, FIG. 1 shows a known cellular radio network and a known WiFi network. Each of the networks are independent of the other, even though coverage provided by each network may overlap in some areas. The cellular radio network includes at least one base station 12 that contain radios that communicate over a defined geographic area called a cell. The base stations 12 may be, for example, evolved Node B, eNB, base stations of an evolved Universal Terrestrial Radio Access Network, eUTRAN, or LTE network. The air interface of the base stations 12 may be orthogonal frequency division multiple access, OFDMA, on the downlink, and single carrier frequency division multiple access, SC-OFDMA, on the uplink.

Each base station 12 may be in communication with a serving gateway S-GW 14 using an Si protocol. The S-GW 14 is a communication interface between the base stations 12 and the Internet and/or a backhaul network. As such, S-GW 14 routes and forwards user data packets, while also acting as the mobility anchor for the user plane during inter-eNB handovers and as the anchor for mobility between LTE and other 3GPP technologies. Each base station also communicates with one or more user equipments 20 which may be cellular mobile phones or smart phones capable of communicating with the cellular radio network and the WiFi network.

The base stations 12 are also in communication with a mobile management entity, MME, 16. The MME 16 is a control node for an LTE access-network. The MME 16 is responsible for idle mode UE tracking and paging procedures. The MME 16 is involved in the bearer activation/deactivation process and is also responsible for choosing the S-GW 14 for a UE 20 at the UE's initial entry into the LTE network and at a time of intra-LTE handover.

The MME 16 is responsible for authenticating the user, for generation and allocation of temporary identities to UEs 28, for authorization of the UE 20 to camp on the service provider's Public Land Mobile Network (PLMN) and enforces UE roaming restrictions. The MME is the termination point in the network for ciphering/integrity protection for non-access stratum, NAS, signaling and handles security key management. Lawful interception of signaling is also supported by the MME 16. Further, the MME 16 also provides the control plane function for mobility between LTE and second generation/third generation, 2G/3G, access networks.

The WiFi network includes wireless access points 18. Each WiFi access point functions as a communication interface between a user equipment 20, such as a mobile phone or computer, and the Internet. The coverage of one or more (interconnected) access points—called hotspots—can extend from an area as small as a few rooms to as large as many square miles. Coverage in the larger area may require a group of access points with overlapping coverage.

Because of growth in volume of wireless data, cellular radio network operators are motivated to increase the capacity of their wireless networks. In the case of 3GPP wireless networks, carrier spectrum is limited and this results in pressure to increase the spectral efficiency in mega bits per second per Megahertz, Mbps/MHz, of the 3GPP air interface. Existing technologies that improve the spectral efficiency of the 3GPP air interface are typically based on solutions that focus on a mixture of the following techniques:
Interference cancellation and mitigation, via enhanced receiver design, such as beam forming;
Interference avoidance, via intelligent scheduling;
Multiple Input Multiple Output techniques which rely on multiple antennas; and
Microcellular diversity techniques such as coordinated multipoint, CoMP.

These solutions rely solely on the cellular carrier's 3GPP spectrum. These methods do not exploit the presence of the WiFi network. However, known solutions that utilize the WiFi network do not provide reliability due to the WiFi's unlicensed spectrum.

### SUMMARY

The present invention advantageously provides a method and devices for coordinating transmissions of two user equipments using two different radio access technologies. According to one aspect, the invention provides a first user equipment capable of communicating via each radio access technology. The first user equipment includes a first radio configured to receive first data from a second user equipment via a first radio access technology. The user equipment also includes a second radio configured to transmit the first data to a base station via a second radio access technology. The first radio access technology is different from the second radio access technology. The transmission of the first data to the base station by the first user equipment is coordinated with transmission of the first data to the base station by the second user equipment via the second radio access technology. The first user equipment also includes a data queue configured to store the first data.

According to this aspect, in one embodiment the first radio access technology is WiFi and the second radio access technology is Long Term Evolution, LTE. The first user equipment may further include a processor configured to cause second data to be transmitted by the first user equipment to the second user equipment via the first radio access technology and, after a predetermined delay, to cause the second data to be transmitted by the first user equipment to the base station via the second radio access technology. In some embodiments, the processor may be configured to determine whether to transmit the first data to the base station based on a power consumption of the first user equipment and to cause transmission of the first data when the power consumption of the first user equipment is below a predetermined threshold. In some embodiments, the first user equipment may include a processor configured to determine whether to transmit the first data to the base station based on an input from a user of the first user equipment. In some embodiments, the data queue may further store an indication of a modulation and coding scheme specified by the base station for the second user equipment. The modulation and coding scheme is used for transmission of the first data by the first user equipment to the base station via the second radio access technology. In some embodiments, the first user equipment includes a processor configured to cause a joint mode report to be transmitted to the base station via the second radio access technology. The joint mode report includes an identity of a plurality of user equipments configured to coordinate transmissions of the first data to the base station via the second radio access technology. The processor may be configured to receive a report from the base station identifying a plurality of user equipments to operate in a joint mode to coordinate transmissions of the first data to the base station via the second radio access technology.

According to another aspect, the invention provides a base station used in coordinated transmissions using two different radio access technologies. The base station has a radio configured to communicate with a plurality of user equipments according to a first radio access technology. The base station also has a processor configured to determine a group of user equipments operating in a joint mode. The joint mode includes coordinated transmission of same data by each of the user equipments in the group.

According to some aspects, in some embodiments, the processor is further configured to select a modulation and coding scheme for communication with the group of user equipments based on a quality of signals from each of the user equipments in the group. In some embodiments, determining the group of user equipments operating in a joint mode includes selecting, by the base station, a plurality of user equipments based on a quality of signals from at least one of the plurality of user equipments. In some embodiments, determining the group of user equipments operating in a joint mode is based on at least one policy of an operator of the base station. In some embodiments, the processor is further configured to select which one of the user equipments of the group is to transmit data to the other user equipments in the group according to a second radio access technology. In some embodiments, the processor is further configured to cause the radio to transmit to at least one of the user equipments in the group an identification of what other user equipments are in the group.

According to yet another aspect, the invention provides a method of coordinated operation of a plurality of user equipments. The method includes receiving, at a first user equipment via a first radio access technology, first data from a second user equipment. The method further includes transmitting, by the first user equipment to a base station via a second radio access technology, the first data received from the second user equipment. The transmitting is in coordination with transmission of the first data to the base station by the second user equipment.

In some embodiments, the coordination is controlled by the base station. In some embodiments, the method further includes transmitting second data from the first user equipment to the second user equipment via the first radio access technology and, after a predetermined delay, transmitting the second data from the first user equipment to the base station via the second radio access technology. In some embodiments the method further includes receiving, at the first user equipment, an instruction from the base station indicating which one of a plurality of user equipments is the second user equipment from which to receive the first data. In some embodiments the method further includes receiving, at the first user equipment, an indication of a modulation and encoding scheme from the second user equipment to be used to transmit the first data by the first user equipment. In some embodiments, the method may further include transmitting to the base station a joint mode report indicating identities of user equipments coordinating their transmissions of the first data. Some embodiments may further include receiving from the base station identities of user equipments whose transmissions are to be coordinated.

According to yet another aspect, the invention provides a method of coordinated operation of a plurality of user equipments, including receiving at a first user equipment via a first radio access technology, first data from a base station. The method also includes transmitting, by the first user equipment to a second user equipment station via a second radio access technology, the first data received from the base station

According to this aspect, in some embodiments, the first user equipment receives, via the first radio access technology from the base station, a message identifying the second user equipment. In some embodiments, only a portion of the first data is transmitted by the first user equipment to the second user equipment. In some embodiments, the portion of the first data is designated by the base station.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of known cellular radio network and a known WiFi network;

FIG. 2 is a block diagram of a communication system having a cellular radio network node, an access point, and user equipments constructed in accordance with principles of the present invention;

FIG. 3 is a diagram of a communication system utilizing two radio access technologies to form and receive transmissions from virtual devices comprising multiple user equipments;

FIG. 4 is a flowchart of an exemplary process coordinating transmissions of a plurality of user equipments; and

FIG. 5 is a flow chart of an exemplary process of cluster and scheduling by a base station to receive coordinated transmissions from a plurality of user equipments.

### DETAILED DESCRIPTION

Before describing in detail exemplary embodiments that are in accordance with the present invention, it is noted that the embodiments reside primarily in combinations of apparatus components and processing steps related to providing coordination of cellular transmissions among user equipments using a coordinating radio access technology, such as WiFi. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Embodiments described herein take advantage of the distributed nature of user equipment in a mobile cellular network in combination with a short range, high data rate second air interface to enable communication directly between user equipments. Embodiments achieve an enhancement of the performance of the mobile cellular network by utilizing a second radio access technology, such as WiFi, to coordinate the cellular radio transmissions of user equipments in proximity to each other. By coordinating the cellular radio transmissions of a plurality of user equipments, spatial diversity can increase the data rate and/or decrease the error rate. By forming a virtual device with more antennas resulting from the coordination, increased multiple input multiple output, MIMO, capabilities may result. Further, the virtual device formed by the coordinated clustering of user equipments can share partial or complete downlink received signals to form a coordinated multipoint, CoMP, receive session. Discovery of nearby devices whose transmissions are to be coordinated may be device driven, and clustering—that is, selection of user equipments whose transmissions are to be coordinated—can be device driven or determined by a base station of the cellular radio network.

As explained herein, the cellular radio network may be of one radio access technology, whereas the radio network for communicating directly between user equipments to coordinate their transmissions may be of another radio access technology. Although embodiments described herein may refer to an LTE network and WiFi network, the invention is not limited to these radio access technologies. The radio access technology whose performance is sought to be improved—in other words, the cellular radio access technology—may have a licensed air interface with wide, medium or local range. Examples include LTE and wide band code division multiple access, WCDMA. The radio access technology used to coordinate transmissions of user equipments in a cluster—referred to herein as the coordinating radio access technology—may have an unlicensed air interface, The coordinating radio access technology should be popularly available in user equipments, and may have a short communication range and a high data rate as compared to the cellular radio access technology. The coordinating radio access technology may be time division duplexed, TDD. Examples of a coordinating radio access technology include WiFi (2.4 Giga-Hertz (GHz), 5 GHz) or WiGig (60 GHz).

Returning now to the drawing figures, there is shown in FIG. 2 a block diagram of a communication system 26 having a cellular radio base station 22, an access point 24, and at least two user equipments 28a and 28b, constructed in accordance with principles of the present invention. Each user equipment 28a and 28b has a radio for each radio access technology. User equipments 28a and 28b are referred to collectively herein as “user equipments 28” or “user equipment 28”. Thus, the user equipment 28a has a first radio transceiver 32a for a radio access technology A, RAT A, and a second radio transceiver 34a for a radio access technology B, RAT B. In this embodiment, the RAT A is a cellular radio technology and RAT B is a coordinating radio access technology.

Similarly, the user equipment 28b has a first radio transceiver 32b for RAT A and a second radio transceiver 34b for RAT B. The RAT A radio transceivers 32a and 32b of user equipments 28a and 28b, respectively, are in communication with a RAT A radio transceiver 40 of the cellular radio base station 22. The RAT B radio transceivers 34a and 34b of user equipments 28a and 28b, respectively, are in communication with a RAT B radio transceiver 42 of the access point 24. Also, the RAT B radio transceiver 34a of the user equipment 28a may be in communication with the RAT B radio transceiver 34b of the user equipment 28b.

Each user equipment 28a and 28b has a queue 44a and 44b, respectively, to store data to be transmitted to the base station 22 or to be transmitted to another UE. For example, the queue 44a of the user equipment 28a may store data that originates from the user equipment 28a, or data that is received from the RAT A radio transceiver 40 of the base station 22, or data that is received from the RAT B transceiver 42 of the access point 24, or data that is received from the RAT B radio transceiver 34b of the user equipment 28b. Similarly, the queue 44b of the user equipment 28b may store data that originates from the user equipment 28b, or data that is received from the RAT A radio transceiver 40 of the base station 22, or data that is received from the RAT B transceiver 42 of the access point 24, or data that is received from the RAT B radio transceiver 34a of the user equipment 28a. Note also that the data queue of each user equipment 28a and 28b may store an indication of a modulation and coding scheme by which to transmit the data via RAT A.

Each user equipment 28a and 28b has a processor 48a and 48b, respectively, that implements cluster discovery and sharing functions. Cluster discovery may result from each user equipment detecting a RAT B signal from one or more other user equipments. When the coordinating radio access technology, RAT B, is a peer to peer network, the user equipments may discover each other without the assistance of the access point 24. Alternatively, the access point 24 may relay information concerning the existence of one UE to another UE. Thus, the processor 48a may, based on a signal from the RAT B radio transceiver 34b of UE 28b received by the RAT B radio transceiver 34a, determine that the UE 28b is in a cluster that includes UEs 28 and 30. The determination may be based on the mere presence of the signal or may be based on estimated device to device link capacity. All UEs 28 of a cluster may thus be UEs that have mutual visibility.

In some embodiments, determinations of which UEs 28 are to be clustered to form a virtual device are made by a processor 52 of the cellular radio base station 22. In such embodiments, the processor 52 may determine groups of UEs 28 to include in a cluster based on factors such as channel information including channel quality and signal strength. Further, the processor 52 may determine a modulation and coding scheme, MCS, based on a number of UEs 28 in a cluster or channel information.

Thus, in one embodiment, the cellular radio base station 22 operates without knowledge of which devices are in a cluster. In another embodiment, the cellular radio base station 22 knows which devices are in a cluster but plays no role in selecting which devices are in a cluster. In this embodiment, the cellular radio base station 22 may schedule payloads from multiple devices in the cluster based on quality of service, QoS, requirements, and MCS adaptation may be proactive, leading to better tracking of channel conditions. In yet another embodiment, the cellular radio base station plays a role in selecting which devices are in a cluster. In this embodiment, the cellular radio base station may increase performance by strategically choosing which devices are in a cluster, and which devices are not to contribute to the coordinated transmission because they do not increase performance, resulting in power savings. Features of these three embodiments are summarized in the following table.

| | | | |
|---|---|---|---|
| Embodiment 1 | Embodiment 2 | Embodiment 3 | |
| device driven, | device driven, | eNB driven, | |
| hidden cluster | known cluster | known cluster | Advantage |

| | | | |
|---|---|---|---|
| Grant | Single | Mixed device grant | Better |
| for UL | device | | fairness |
| trans- | | | |
| mission | | | |
| MCS | Reactive | Proactive | Better |
| adapta- | | | Throughput |
| tion | | | |

| | | | |
|---|---|---|---|
| Optimal | | eNB decides | Increased |
| Sub- | | which groups | Performance |
| Groups | | are best. | |
| Power | Local decisions | Global | Targeted |
| saving | | decisions | Power |

For example, in embodiment 1, where the cluster is device driven and cluster membership is hidden from the base station, the grant from the base station for transmission is directed to a single device. In embodiments 2 and 3, where the cluster is known to the base station, the base station may grant transmission to more than one device in the cluster. In embodiment 1, a modulation and coding scheme, MCS, is assigned reactively in response to a channel quality indication. In embodiments 2 and 3, MCS adaptation is proactive, based on an aggregated channel quality indication. When the cluster membership is device driven, as in embodiments 1 and 2, power saving decisions are made by the individual devices in the cluster. Also, when the cluster membership is device driven, each device may decide whether to join the cluster based on considerations other than available power. For example, a user of the device may be able to set the device to participate or not participate. In contrast, when the base station selects the devices to be in a cluster, as in embodiment 3, power saving decisions are made by the base station. Further, when the base station selects which of the devices in a cluster are to participate, the selections may be based on a policy of the operator of the base station. Such a policy may include a level of service to be provided to one or more devices in the cluster.

Operation of the communication system 26 may be explained with reference to FIG. 3. FIG. 3 shows two virtual devices 33a and 33b. Virtual Device 33a is formed by the cluster of UE 28c, UE 28d and UE 28e. Virtual device 33b is formed by the cluster of UE 28a and UE 28b. As a first example, suppose that the base station 22 has no knowledge of which devices are in the virtual device 33b, and grants access to UE 28a to transmit its payload over the cellular radio access technology, RAT A. Since UE 28b is in the same cluster as UE 28a, UE 28a transmits data that it has pending for transmission to the base station 22, to UE 28b using RAT B. UE 28b stores this data in its queue and prepares to send it to the base station 22 using RAT A. Subsequently, the UE 28a and the UE 28b simultaneously transmit the pending data to the base station using RAT A.

In this example, if the base station has no knowledge of which devices participate in the virtual device, only a single UE 28 is granted permission to transmit. Further, the MCS that is chosen may not be based on knowledge that UE 28b is participating in the virtual device transmission. However, due to the simultaneous transmission of the two UEs 28a and 28b, the link rate increases and the probability of receiving the data at the base station 22 without error increases. Note that when the number of devices in a cluster is based on device driven discovery, additional devices might be added that have a diminishing impact on performance. Also, in this example, each device in the cluster of virtual device 33b may decide on its own whether it has enough reserve power, such as battery power or processing power, to participate in the coordinated transmission process. Further, several devices may arrive at a consensus as to which devices will be joined to form a virtual device. Such partitioning may be based on performance, such as channel quality.

Suppose now that the base station 22 knows that UEs 28c, 28d and 28e form a virtual device 33a. For example, the base station 22 may receive a joint mode report from one of the UEs 28 in the virtual device 33a listing the UEs 28 in the virtual device. In this example, multiple devices can be granted to offload data simultaneously. Also, the base station 22 can adjust the MCS based on the knowledge of the devices participating in the virtual device 33a. Control information can be communicated between the UEs 28 of the virtual device 33a and the base station 22, to keep the base station 22 informed of which devices are in the virtual device 33a. In some embodiments, the base station 22 estimates the aggregate channel formed by the simultaneous transmission of the UEs 28 of the virtual device 33a and may use the estimated aggregate channel to select the MCS. Assume now that the base station 22 grants access to UE 28d to transmit its payload and stipulates that the payload from the other UEs 28 in the virtual device 33a are to be included in the payload transmitted to the base station 22. The UEs 28 in the virtual device 33a will communicate to each other, via RAT B, and prepare for a joint transmission of the total payload, via RAT A. Then the UEs 28 of virtual device 33a will jointly transmit the total payload to the base station 22 via RAT A.

Assume now that the base station 22 actually participates in the selection of the UEs 28 that are in each virtual device. For example, assume that UEs. 28a-e are all mutually visible to each other, as determined by RAT B communications between the UEs 28. The mutual visibility may be reported to the base station 22 via RAT A. Based on one or more parameters such as channel quality of the RAT A signals from the UEs 28, or based on channel state or scheduling constraints, the base station 22 will group the UEs 28a-e into 1 or more virtual devices. For example, as shown in FIG. 3, the UEs 28 may be grouped into two virtual devices 33a and 33b. The base station 22 may communicate to the UEs 28 a report to let the UEs 28 know what other UEs 28 they are grouped with. When the base station 22 chooses which UEs 28 to use to form a virtual device, the base station 22 can manage when the two virtual devices will communicate via RAT B and, by avoiding provision of concurrent grants to both virtual devices, can manage collisions on the RAT B. Further, the base station may group UEs 28 into virtual devices in such a way as to optimize performance of the virtual devices based on information such as channel information.

A flow chart of an exemplary process for coordinating transmissions of a plurality of user equipments is described with reference to FIG. 4. A plurality of UEs 28 are selected to operate in a joint mode (block S100). A first one of the selected UEs, for example UE 28a, receives, via a first radio access technology (RAT B), first data from a second one of the selected UEs, for example UE 28b (block S102). Transmissions of the first data by the selected UEs 28a and 28b is coordinated to occur simultaneously (block S104). In some embodiments, the coordination may be controlled by a base station. For example, the base station may send an instruction to the first UE indicating from which one of the other UEs 28 to receive data. The selected UEs 28 transmit the data simultaneously via a second radio access technology (RAT A) (block S106). As noted above, in one embodiment, the RAT A may be LTE and RAT B may be WiFi.

FIG. 5 is a flow chart of an exemplary process performed at a base station for communicating with a virtual device. The base station may determine the identity of UEs 28 operating in a joint mode, i.e., as a virtual device (block S108). Or alternatively, the base station may receive a joint mode report indicating identities of the UEs 28 operating in a joint mode. Based on information such as channel quality, the base station determines a modulation and coding scheme, MCS, by which the UEs 28 operating in the joint mode are to transmit (block S110). An indication of the determined MCS is communicated to the UEs 28 operating in the joint mode (block S112). In an alternative embodiment, the MCS may be communicated between the devices operating in the joint mode.

While embodiments have been described primarily for coordination of uplink transmissions, coordination of downlink transmissions is also contemplated. Thus, the base station 22 may transmit a block of data to all the UEs 28 in a virtual device, such as virtual device 33a, via RAT A, and indicate to which one of the plurality of UEs 28 the block of data is ultimately intended. Each other UE will then transmit the received data block, or portions of the received data block, to the intended destination UE via RAT B. Since the intended destination UE may receive the same data from multiple sources, error-free recovery of the data block may increase. In some embodiments, the data sent to the plurality of UEs 28 indicates the modulation and encoding scheme to be employed by the intended destination UE. In some embodiments, one or more UEs that receive the data block on the downlink may be selected to deliver only part of the data block to the intended destination UE. For example, the base station may designate one intermediate UE to send only delay tolerant data to the destination UE, whereas the base station may designate another intermediate UE to send only delay intolerant data to the destination UE. Such designations may be based on QoS considerations, for example.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A first user equipment, comprising:
a first radio configured to receive first data from a second user equipment via a first radio access technology;
a second radio configured to transmit the first data to a base station via a second radio access technology, the first radio access technology being different from the second radio access technology, the transmission of the first data to the base station by the first user equipment being coordinated with transmission of the first data to the base station by the second user equipment via the second radio access technology; and
a data queue configured to store the first data.

2. The first user equipment of claim 1, wherein the first radio access technology is WiFi and the second radio access technology is Long Term Evolution, LTE.

3. The first user equipment of claim 1, further comprising a processor, the processor configured to cause second data to be transmitted by the first user equipment to the second user equipment via the first radio access technology and, after a predetermined delay, to cause the second data to be transmitted by the first user equipment to the base station via the second radio access technology.

4. The first user equipment of claim 1, further comprising a processor, the processor configured to determine whether to transmit the first data to the base station based on a power consumption of the first user equipment and to cause transmission of the first data when the power consumption of the first user equipment is below a predetermined threshold.

5. The first user equipment of claim 1, further comprising a processor, the processor configured to determine whether to transmit the first data to the base station based on an input from a user of the first user equipment.

6. The first user equipment of claim 1, wherein the data queue of the first user equipment further stores an indication of a modulation and coding scheme specified by the base station for the second user equipment, the modulation and coding scheme being used for transmission of the first data by the first user equipment to the base station via the second radio access technology.

7. The first user equipment of claim 1, further comprising a processor configured to cause a joint mode report to be transmitted to the base station via the second radio access technology, the joint mode report including an identity of a plurality of user equipments configured to coordinate transmissions of the first data to the base station via the second radio access technology.

8. The first user equipment of claim 1, further comprising a processor configured to receive a report from the base station identifying a plurality of user equipments to operate in a joint mode to coordinate transmissions of the first data to the base station via the second radio access technology.

9. A base station, comprising:
a radio configured to communicate with a plurality of user equipments according to a first radio access technology; and
a processor configured to determine a group of user equipments operating in a joint mode, the joint mode including coordinated transmission of same data by each of the user equipments in the group.

10. The base station of claim 9, wherein the processor is further configured to select a modulation and coding scheme for communication with the group of user equipments based on a quality of signals from each of the user equipments in the group.

11. The base station of claim 9, wherein determining the group of user equipments operating in a joint mode includes selecting, by the base station, a plurality of user equipments based on a quality of signals from at least one of the plurality of user equipments.

12. The base station of claim 9, wherein determining the group of user equipments operating in a joint mode is based on at least one policy of an operator of the base station.

13. The base station of claim 9, wherein the processor is further configured to select which one of the user equipments of the group is to transmit data to the other user equipments in the group according to a second radio access technology.

14. The base station of claim 9, wherein the processor is further configured to cause the radio to transmit to at least one of the user equipments in the group an identification of what other user equipments are in the group.

15. A method of coordinated operation of a plurality of user equipments, the method comprising:
receiving, at a first user equipment via a first radio access technology, first data from a second user equipment; and
transmitting, by the first user equipment to a base station via a second radio access technology, the first data received from the second user equipment, the transmitting being in coordination with transmission of the first data to the base station by the second user equipment.

16. The method of claim 15, wherein the coordination is controlled by the base station.

17. The method of claim 15, further comprising transmitting second data from the first user equipment to the second user equipment via the first radio access technology and, after a predetermined delay, transmitting the second data from the first user equipment to the base station via the second radio access technology.

18. The method of claim 15, further comprising receiving, at the first user equipment, an instruction from the base station indicating which one of a plurality of user equipments is the second user equipment from which to receive the first data.

19. The method of claim 15, further comprising receiving, at the first user equipment, an indication of a modulation and encoding scheme from the second user equipment to be used to transmit the first data by the first user equipment.

20. The method of claim 15, further comprising transmitting to the base station a joint mode report indicating identities of user equipments coordinating their transmissions of the first data.

21. The method of claim 15, further comprising receiving from the base station identities of user equipments whose transmissions are to be coordinated.

22. A method of coordinated operation of a plurality of user equipments, the method comprising:
receiving, at a first user equipment via a first radio access technology, first data from a base station; and
transmitting, by the first user equipment to a second user equipment station via a second radio access technology, the first data received from the base station.

23. The method of claim 22, further comprising receiving, at the first user equipment via the first radio access technology, a message from the base station identifying the second user equipment.

24. The method of claim 22, wherein only a portion of the first data is transmitted by the first user equipment to the second user equipment.

25. The method of claim 24, wherein the portion of the first data is designated by the base station.
